(19) United States
(12) Patent Application Publication
(10) Pub. No.: US 2025/0137901 A1
(43) Pub. Date: May 1, 2025

(54) Tuning Aerosolization Parameters to Distinguish the Contributions of Particle and Particle-Precursor Concentrations for Liquid Samples

(71) Applicant: Kanomax FMT, Inc., White Bear Lake, MN (US)

(72) Inventors: Derek OBERREIT, Roseville, MN (US); Michael WALKER, Minneapolis, MN (US); Jikku THOMAS, St Paul, MN (US)

(73) Assignee: Kanomax FMT, Inc., White Bear lake, MN (US)

(21) Appl. No.: 18/933,915

(22) Filed: Oct. 31, 2024

Related U.S. Application Data
(60) Provisional application No. 63/594,845, filed on Oct. 31, 2023.

(51) Int. Cl. G01N 15/06; G01N 1/38

(52) U.S. Cl. CPC G01N 15/06; G01N 1/38

(57) ABSTRACT

The present disclosure involves continuous measurement of the likelihood of a semiconductor-process chemical to form wafer defects composed primarily of particle-precursor material. Specifically, this disclosure details methods to estimate the effects of terminal size and contact angle for droplets remaining on a wafer following a spin-dry process. In some examples, the methods involve tuning a liquid-to-aerosol-based measurement device to correlate the measurement value with the tendency of a chemical to form such defects.

### CROSS-REFERENCE TO RELATED APPLICATIONS, IF ANY

This application claims the benefit under 35 U.S.C. § 119 (e) of co-pending U.S. Provisional Patent Application Ser. No. 63/594,845, filed Oct. 31, 2023, which is hereby incorporated by reference.

If an Application Data Sheet(s) (ADS) has been filed in this application, it is incorporated by reference herein. Any applications claimed in an ADS for priority under 35 USC 119, 120, 121 or 365, and any and all parent, grandparent, great-grandparent, etc. applications of such applications, are also incorporated by reference, including any priority claims made in those applications and any material incorporated by reference, to the extent such subject matter is not inconsistent herewith.

### NOTICE OF COPYRIGHTS AND TRADE DRESS 37 C.F.R. § 1.71 (e) AUTHORIZATION

A portion of the disclosure of this patent document may contain material which is subject to copyright protection, or which has become trade dress. The copyright and trade dress owner has no objection to the facsimile reproduction by anyone of the patent document or the patent disclosure, as it appears in the US Patent and Trademark Office patent file or records, but otherwise reserves all copyright and trade dress rights whatsoever.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

### 1. Field of the Invention

The present disclosure relates to continuous measurement of the likelihood of a semiconductor-process chemical to form wafer defects composed primarily of particle-precursor material. Specifically, this disclosure details methods to estimate the effects of terminal size and contact angle for droplets remaining on a wafer following a spin-dry process. In some examples, the methods involve tuning a liquid-to-aerosol-based measurement device to correlate the measurement value with the tendency of a chemical to form such defects.

### 2. Background Information

Manufacturing of semiconductor devices utilizes several different compositions of liquid chemicals for cleaning, etching, and drying wafers. At the conclusion of these chemical applications, wafers are spun at a high RPM to remove the majority of the liquid. Following this process, small droplets of the chemical remain on the wafer, and after evaporation, will deposit non-volatile material onto the wafer.

### BRIEF SUMMARY OF THE INVENTION

Disclosed herein are methods for selecting improved operation parameters for a liquid-to-aerosol-based measurement device to distinguish between particle-based and particle-precursor-based Non-Volatile Residue (NVR) in the liquid sample. NVR from evaporated liquids can be separated into the following categories:
discrete, stable, solid particles;
discrete, meta-stable particles (emulsions and micelles);
non-uniformly-dispersed dissolved material; and
uniformly-dispersed dissolved material.

When a liquid is dispersed into droplets on a wafer, the NVR in the droplets will form discrete particles and/or films after evaporation. For liquid-to-aerosol-based measurement devices, the mechanism of particle formation through evaporation of surface droplets is mimicked via nebulization-evaporation.

The present methods also involve optimizing (i.e., selecting improved) operating parameters of the measurement device to correlate the measured concentration with defect concentration found on wafers due to NVR in the liquid sample.

The aspects, features, advantages, benefits, and objects of the invention will become clear to those skilled in the art by reference to the following description, claims and drawings.

### BRIEF DESCRIPTION OF THE SEVERAL VIEWS OF THE DRAWINGS

FIG. 1 is a particle-size-distribution graph, demonstrating a theoretical configuration for improved particle detection (for particle diameters greater than about 9 nanometers (nm), and at a background precursor concentration of about 100 parts-per-trillion (ppt)).

FIG. 2 is a particle-size-distribution graph, demonstrating the isolation of native and precursor particles by modifying the droplet-size distribution.

### DETAILED DESCRIPTION

The following disclosure describes, illustrates, and exemplifies one or more embodiments of the present invention. This description is not provided to limit the disclosure to the embodiments described herein, but rather to explain and teach various principles to enable one of ordinary skill in the art to understand these principles and, with that understanding, be able to apply them to practice not only the embodiments described herein, but also other embodiments that may come to mind in accordance with these principles. The scope of the instant disclosure is intended to cover all such embodiments that may fall within the scope of the appended claims, either literally or under the doctrine of equivalents.

It should be noted that, in the description and drawings, like or substantially similar elements may be labeled with the same reference numerals. However, sometimes these elements may be labeled with differing numbers in cases where such labeling facilitates a more clear description. Additionally, the drawings set forth herein are not necessarily drawn to scale, and in some instances proportions may have been exaggerated to more clearly depict certain features.

Existing aerosolization-based methods can discriminate between native particles and particle precursors by utilizing online dilution of a liquid sample. With online dilution, the native particles in the sample (particles that are stable, and discrete from the bulk chemical) will not change in size, and the total number concentration will vary proportionally to the dilution ratio. For particle-precursor material, the peak diameter of the resulting aerosol-size distribution will shift to a lower size with increasing dilution ratio, while the total number concentration will remain generally unchanged. While this technique is useful for samples where the precursor-based aerosol particles are sufficiently separated from the native particles, it does not provide the same facile distinction when these distributions overlap.

For this measurement method to correlate with wafter defects, the nebulized-droplet-size distribution prior to evaporation must be representative of the size distribution of droplets on the wafer at the conclusion of a rinsing process. This wafer-droplet distribution may be affected by the surface properties of the wafer (e.g., hydrophobic/hydrophilic, etc.) as well as the liquid properties (e.g., surface tenson, vapor pressure, viscosity, contact angle with the wafer surface, etc.).

The present disclosure describes how the aerosolization-detection process may be manipulated to allow for clearer insights into the particle and particle-precursor concentrations in liquid samples, and the resulting correlation with expected wafer-defect densities.

In accordance with these principles, a first method involves manipulation of one or more of the following operation variables, either with or without variable online dilution:
the initial nebulized droplet-size distribution;
the post-nebulization droplet-size distribution;
the aerosolized particle-size distribution; and
the aerosol-particle detector.

The following are detailed descriptions of how these operation variables can be manipulated, and a description of the effect they will have on the measurement output:

### Methods for Setup/Calibration of the Measurement System:

Manipulation of the initial nebulized droplet-size distribution
   Adjust peak diameter of polydisperse droplet-size distribution
      Ultrasonic (standing wave)
         Frequency/Amplitude
         Liquid flowrate
      Pneumatic
         Orifice/capillary diameter(s)
         Gas pressure
         Liquid flowrate
   Adjust peak diameter of monodisperse droplet-size distribution
      Ultrasonic (vibrating orifice or capillary)
         Frequency/Amplitude
         Liquid flowrate
         Diameter of liquid conduit
         Carrier gas flowrate to regulate coagulation frequency/contribution
      Rayleigh jet
         Liquid flowrate
         Diameter of liquid conduit
         Carrier-gas flowrate to regulate coagulation frequency/contribution
Manipulation of the post-nebulization droplet-size distribution
   Using inertial impaction to break up large droplets into smaller droplets;
   Using inertial impaction to remove large droplets;
   Using charge-based separation;
   Using aerodynamic separation
      Cross-flow;
   Using Stokes separation (inertia+aerodynamic);
   Using virtual impaction.
Manipulation of the aerosolized particle-size distribution
   Selective drying
   Size isolation
      DMA
   Adjust shape
      Diffusion-based deposition (screens/capillaries)
      Thermophoretic
Manipulation of the aerosol-particle detector
   Condensation Particle Counter (CPC)
      Detection threshold by adjusting peak saturation ratio
         By adjusting temperatures
         By adjusting the vapor pressure prior to conditioner
      Slope of detection-efficiency curve
         Sheathing
         Selective droplet-detection (centerline)
   Electrometer
      Adjust charging current
   Optical scattering aggregate (nephelometer)
      Adjust laser power, detection
      Detection angle, detector
      Detector gain

Method for configuring measurement system—the operating parameters for this measurement system are adjusted to optimize two performance metrics:
Distinction between native particles and particle precursors
   Isolation of native particles: addition of dissolved material does not affect signal, up to a defined concentration at a desired detection-threshold diameter
   Optimized sensitivity to precursor material: system can detect low-concentration additions of dissolved material
Correlation of measurement with wafer defects

The following are detailed descriptions for how each of these metrics can be optimized:
Distinction between native particles and particle precursors for a given sample by manipulating droplet-size distribution and detector sensitivity
   Challenge device with monodisperse particles with a known size and concentration.
      Size of challenge particles is the smallest diameter a user wishes to detect without influence by particle-precursor material
   Add dissolved precursor material to the challenge particles
      Preferably using on-line mixing versus spiking bottle samples
      Concentration chosen to be the maximum-allowable precursor concentration that will not influence the measurement
   Adjust operating parameters to fully detect the challenge-particles signal, while not showing a change when particle-precursor material is added to the challenge particles (up to a specified concentration)
Distinction between native particles and particle precursors for a given sample by manipulating peak diameter of monodisperse (Geometric Standard Deviation<1.1) droplet-size distribution and detection threshold of detector
   Separation of peak diameters sufficient to “straddle” the width of the detector-efficiency curve
   Adjust the detector sensitivity while alternating between large and small peak-droplet diameters.
   The size threshold for the detector may then be used to calculate the PP concentration and the particle concentration will be separated from the precursor contribution
Correlation with wafer defects
   Prepare wafer with desired properties (e.g., contact angle, etc.)
   Coat wafers with dissolved precursor material
   For conditions where the PP material precipitates at the liquid/wafer boundary forming a drying ring:
      Measure the size distribution of the drying rings on the wafer
      Adjust the droplet-size distribution of the nebulizer to match the size of the drying rings.
   For conditions where the PP forms a precipitated particle:
      Measure the particle-size distribution on the wafer
      Challenge the metrology with the same dissolved precursor concentration
      Adjust parameters where the dry-aerosol particle-size distribution matches the wafer PSD.

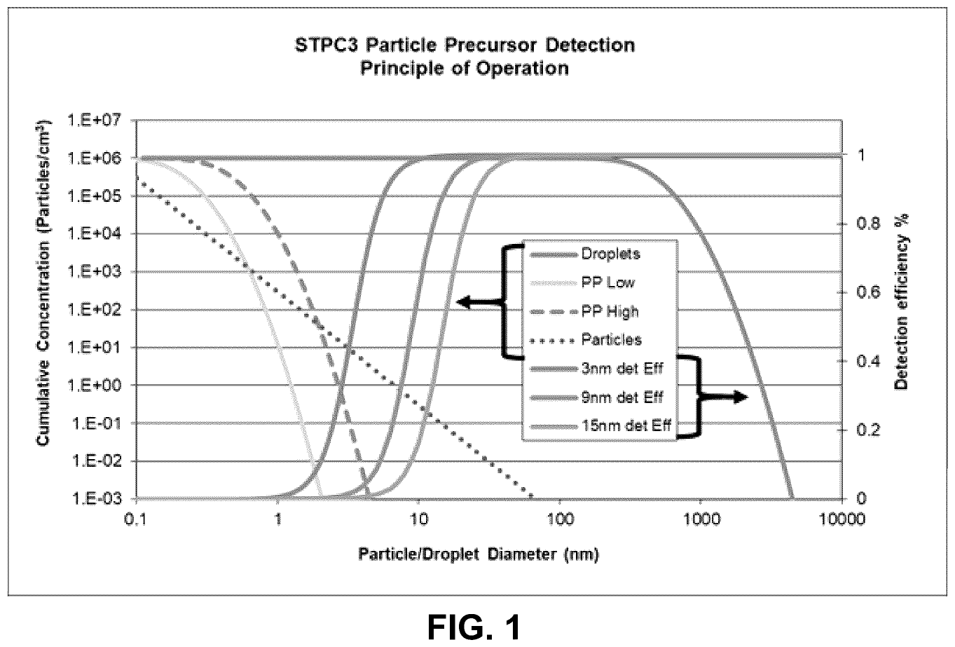

FIG. 1 is a particle-size-distribution graph, demonstrating a theoretical configuration for improved particle detection (for diameters greater than about 9 nanometers (nm), and at a background precursor concentration of about 100 parts-per-trillion (ppt)).

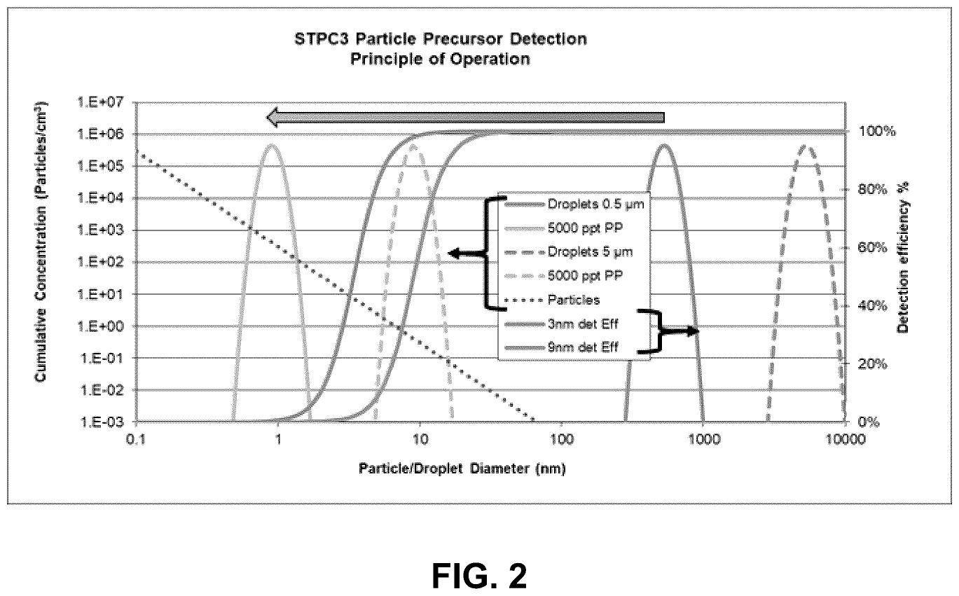

FIG. 2 is a particle-size-distribution graph, demonstrating the isolation of native and precursor particles by modifying the droplet-size distribution.

Although the systems, apparatus, and methods of the invention have been described in connection with the field of chemical measurement and analysis, it can readily be appreciated that the invention is not limited solely to such fields, and can be used in other fields.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

Although the invention or elements thereof may by described in terms of vertical, horizontal, transverse (lateral), longitudinal, and the like, it should be understood that variations from the absolute vertical, horizontal, transverse, and longitudinal are also deemed to be within the scope of the invention.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

The invention claimed is:

1. A method of determining a relative particle concentration and a relative particle-precursor concentration in a liquid sample, and of determining a correlation of the concentrations with expected wafer-defect densities, wherein the method comprises manipulation of at least one of:
an initial nebulized droplet-size distribution;
a post-nebulization droplet-size distribution;
an aerosolized particle-size distribution; and
an aerosol particle detector.

2. The method of claim 1, wherein manipulation of the initial nebulized droplet-size distribution comprises adjusting a peak diameter of a polydisperse droplet-size distribution.

3. The method of claim 2, wherein adjusting the peak diameter of the polydisperse droplet-size distribution comprises adjusting an ultrasonic frequency or amplitude.

4. The method of claim 2, wherein adjusting the peak diameter of the polydisperse droplet-size distribution comprises adjusting an ultrasonic liquid flow rate.

5. The method of claim 2, wherein adjusting the peak diameter of the polydisperse droplet-size distribution comprises adjusting a pneumatic orifice diameter or capillary diameter.

6. The method of claim 2, wherein adjusting the peak diameter of the polydisperse droplet-size distribution comprises adjusting a pneumatic gas pressure.

7. The method of claim 2, wherein adjusting the peak diameter of the polydisperse droplet-size distribution comprises adjusting a pneumatic liquid flow rate.

8. The method of claim 1, wherein manipulation of the initial nebulized droplet-size distribution comprises adjusting a peak diameter of a monodisperse droplet-size distribution.

9. The method of claim 8, wherein adjusting the peak diameter of the monodisperse droplet-size distribution comprises adjusting an ultrasonic frequency or amplitude.

10. The method of claim 8, wherein adjusting the peak diameter of the monodisperse droplet-size distribution comprises adjusting an ultrasonic liquid flow rate.

11. The method of claim 8, wherein adjusting the peak diameter of the monodisperse droplet-size distribution comprises adjusting an ultrasonic diameter of a liquid conduit.

12. The method of claim 8, wherein adjusting the peak diameter of the monodisperse droplet-size distribution comprises adjusting an ultrasonic carrier-gas flowrate to regulate coagulation frequency or contribution.

13. The method of claim 8, wherein adjusting the peak diameter of the monodisperse droplet-size distribution comprises adjusting a Rayleigh jet liquid flow rate.

14. The method of claim 8, wherein adjusting the peak diameter of the monodisperse droplet-size distribution comprises adjusting a Rayleigh jet diameter of a liquid conduit.

15. The method of claim 8, wherein adjusting the peak diameter of the monodisperse droplet-size distribution comprises adjusting a Rayleigh jet carrier-gas flowrate to regulate coagulation frequency or contribution.

16. The method of claim 1, wherein manipulation of the post-nebulization droplet-size distribution comprises using inertial impaction to break up large droplets into smaller droplets.

17. The method of claim 1, wherein manipulation of the post-nebulization droplet-size distribution comprises using inertial impaction to remove large droplets.

18. The method of claim 1, wherein manipulation of the post-nebulization droplet-size distribution comprises using charge-based separation.

19. The method of claim 1, wherein manipulation of the post-nebulization droplet-size distribution comprises using aerodynamic cross-flow separation.

20. The method of claim 1, wherein manipulation of the post-nebulization droplet-size distribution comprises using Stokes separation.

21. The method of claim 1, wherein manipulation of the post-nebulization droplet-size distribution comprises using virtual impaction.
